(19) United States
(12) Patent Application Publication
(10) Pub. No.: US 2019/0367151 A1
(43) Pub. Date: Dec. 5, 2019

(54) SEALABLE SECURING SYSTEMS AND METHODS

(71) Applicant: THE BOEING COMPANY, Chicago, IL (US)

(72) Inventors: Cory Hitchcock, Granite Falls, WA (US); Douglas Allen Lods, Bothell, WA (US); Michael D. Maultsby, Everett, WA (US)

(73) Assignee: THE BOEING COMPANY, Chicago, IL (US)

(21) Appl. No.: 15/992,256

(22) Filed: May 30, 2018

(51) Int. Cl. B64C 1/40; F16B 1/00; A44B 18/00

(52) U.S. Cl. CPC B64C 1/403; F16B 1/00; F16J 15/022; F16B 2001/0028; A44B 18/0069

(57) ABSTRACT

A sealable securing system includes a hook member including a first base, at least one hook group coupled to the first base, and a first seal coupled to the first base. The hook member is configured to be secured to a first component. A loop member includes a second base, at least one loop group coupled to the second base, and a second seal coupled to the second base. The loop member is configured to be secured to a second component. The hook member and the loop member are configured to removably secure to one another.

### FIELD OF EMBODIMENTS OF THE DISCLOSURE

Embodiments of the present disclosure generally relate to securing systems, such as hook and loop securing systems, and more particularly to securing systems that provide a sealing interface between first and second portions.

### BACKGROUND OF THE DISCLOSURE

As an airplane is operated, moisture may be introduced into a pressurized space from passengers, cargo, and/or the environment that condenses and deposits frost on cold structures and equipment. During aircraft design and manufacture, special consideration is given with respect to the potential of moisture accumulation within the airplane, so as to ensure that corrosion of various internal structures, short-circuiting, arcing, and/or degradation of electrical components, do not occur. Further, designers also seek to minimize occupant discomfort from liquid water dropping from the ceiling of the airplane. In general, condensation and deposition are directly related to environmental conditions within an interior cabin of the airplane, and indirectly related to ambient conditions outside of the airplane.

Water accumulation due to condensation and deposition occurs in both short and long range flights, but is generally more prevalent in continuous long-range flights over six hours. Airplanes typically include various moisture management devices to prevent, minimize, reduce, or otherwise control moisture within an interior cabin. For example, drainage paths within various structures, moisture impermeable insulation blankets, dehumidifiers, and moisture management devices are used to capture and/or direct moisture away from the interior cabin and divert the moisture to a bilge, through which the moisture is expelled overboard.

Insulation blankets within an airplane are often connected to one another through hook and loop interfaces. The hook and loop interfaces secure adjacent insulation blankets together along their edges. Testing has shown that moist air can pass through the hook and loop interfaces. The moist air may then contact a sub-freezing component of the airplane during a flight, and be deposited as frost. The frost later melts and can drip or otherwise leak into the interior of the airplane.

The hook and loop interface does not prevent moist air from passing therethrough and being deposited as frost on sub-freezing components. The extent of frost accumulation is a function of cabin humidity and the length of a flight. Humidity is a function of passenger count. For example, four hundred passengers on an eighteen hour flight may generate over one hundred gallons of water, increasing the airplane interior humidity. A quarter of such moisture can then be deposited as frost on sub-freezing components. Hook and loop interfaces between adjacent insulation blankets typically allow passage of the humid air. The passage of humid air increases frost accumulation, which, in turn, leads to water dripping or otherwise leaking into the interior cabin of the airplane.

### SUMMARY OF THE DISCLOSURE

A need exists for a system and method of preventing, minimizing, or otherwise reducing moisture passage through a hook and loop interface. A need exists for a system and method of preventing, minimizing, or otherwise reducing moisture transport through connection interfaces of insulation blankets within an aircraft.

With those needs in mind, certain embodiments of the present disclosure provide a sealable securing system that includes a hook member including a first base, at least one hook group coupled to the first base, and a first seal coupled to the first base. The hook member is configured to be secured to a first component. A loop member includes a second base, at least one loop group coupled to the second base, and a second seal coupled to the second base. The loop member is configured to be secured to a second component. The hook member and the loop member are configured to removably secure to one another. The hook group(s) securely connects to the loop group(s) when the hook member is connected to the loop member. The first seal engages the second seal when the hook member is connected to the loop member, thereby providing an improved barrier against moisture transport.

In at least one embodiment, a first hook group is spaced apart from a second hook group, and a first loop group is spaced apart from a second loop group. The first seal may extend from the first base between the first hook group and the second hook group. The second seal may extend from the second base between the first loop group and the second loop group.

The hook group(s) and the first seal may extend along an entire length of the first base. The loop group(s) and the first seal may extend along an entire length of the second base.

In at least one embodiment, the first seal is wider than the second seal. Optionally, the second seal is wider than the first seal.

Each of the first seal and the second seal may be formed of closed-cell foam.

In at least one embodiment, the hook group(s) includes a plurality of hooks, and the loop group(s) includes a plurality of loops. The plurality of hooks is configured to selectively mate with the plurality of loops.

One or both of the first seal or the second seal may include a rounded, outwardly-bowed surface. One or both of the first seal or the second seal may include a bulb seal. One of the first seal or the second seal may include a plurality of resilient blade seals.

Certain embodiments of the present disclosure provide a sealable securing method that includes providing a hook member including a first base, at least one hook group coupled to the first base, and a first seal coupled to the first base on a first component, providing a loop member including a second base, at least one loop group coupled to the second base, and a second seal coupled to the second base on a second component, and removably securing the hook member to the loop member.

In at least one embodiment, the removably securing includes securely connecting the hook group(s) to the loop group(s) when the hook member is connected to the loop member, and sealingly engaging the first seal and the second seal when the hook member is connected to the loop member.

Certain embodiments of the present disclosure provide a vehicle including an interior cabin, a first insulation blanket within the interior cabin, a second insulation blanket within the interior cabin, and a sealable securing system that sealingly and securely connects the first insulation blanket and the second insulation blanket.

### BRIEF DESCRIPTION OF THE DRAWINGS

FIG. 1 illustrates a top view of a sealable securing system including a hook member and a loop member in a disconnected state, according to an embodiment of the present disclosure.

FIG. 2 illustrates an end view of the sealable securing system including the hook member and the loop member in a connected state.

FIG. 3 illustrates a top view of a sealable securing system including a hook member secured to a first component, and a loop member secured to a second component, according to an embodiment of the present disclosure.

FIG. 4 illustrates a lateral view of the first component connected to the second component via the sealable securing system.

FIG. 5 illustrates a perspective lateral view of a sealable securing system, according to an embodiment of the present disclosure.

FIG. 6 illustrates an end view of a sealable securing system in a disconnected state, according to an embodiment of the present disclosure.

FIG. 7 illustrates an end view of the sealable securing system in a connected state, according to an embodiment of the present disclosure.

FIG. 8 illustrates an end view of a first component connected to a second component by a sealable securing system in which a first seal and a second seal are aligned along respective longitudinal axes, according to an embodiment of the present disclosure.

FIGS. 9 and 10 illustrate end views of the first component connected to the second component by the sealable securing system in which the first seal and the second seal are coupled together and offset from alignment along respective longitudinal axes.

FIG. 11 illustrates an end view of a first component connected to a second component by a sealable securing system, according to an embodiment of the present disclosure.

FIG. 12 illustrates an end view of a first component connected to a second component by a sealable securing system, according to an embodiment of the present disclosure.

FIG. 13 illustrates an end view of a first component connected to a second component by a sealable securing system, according to an embodiment of the present disclosure.

FIG. 14 illustrates a perspective view of the first component connecting to the second component by the sealable securing system, according to an embodiment of the present disclosure.

FIG. 15 illustrates a front perspective view of a vehicle, according to an embodiment of the present disclosure.

FIG. 16 illustrates a perspective internal view of a portion of a fuselage of an aircraft, according to an embodiment of the present disclosure.

FIG. 17 illustrates a perspective internal view of a passenger cabin of an aircraft, according to an embodiment of the present disclosure.

FIG. 18 illustrates a flow chart of a method of securely and sealingly connecting a first component to a second component, according to an embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Certain embodiments of the present disclosure provide a sealable securing system and method that includes a hook member and a loop member that are configured to removably secure to one another. The hook member includes at least one group of hooks, while the loop member includes at least one group of loops. The group of hooks and the group of loops are configured to selectively connect and disconnect from one another. In a connected state, the group of hooks and the group of loops securely couple the hook member to the loop member.

The hook member also includes a first seal, while the loop member also includes a second seal. In the connected state, the first seal compressively couples to the second seal, thereby providing a fluid-tight seal therebetween. As such, the compressive coupling between the first seal and the second seal eliminates, prevents, or otherwise reduces fluid (both gas, such as air, and liquid, such as water) passage therebetween and therethrough.

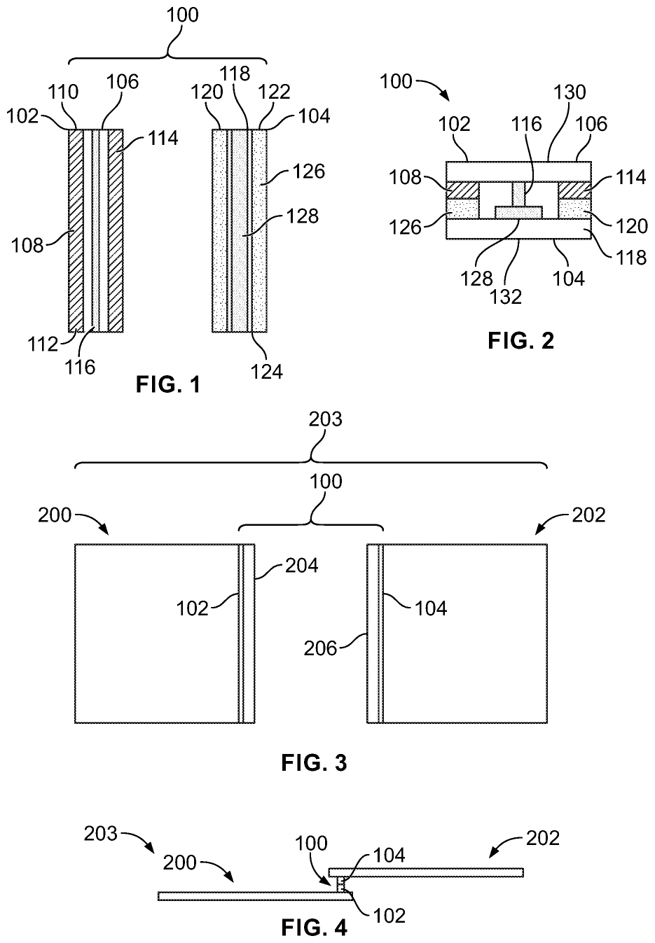

FIG. 1 illustrates a top view of a sealable securing system 100 including a hook member 102 and a loop member 104 in a disconnected state, according to an embodiment of the present disclosure. The hook member 102 and the loop member 104 are configured to selectively connect and disconnect from one another.

The hook member 102 includes a base 106 (for example, a first base), such as a planar strip of plastic, an elastomeric material, a film, and/or the like. A first hook group 108 is coupled to the base 106, and extends along the base 106 from a first end 110 to an opposite second end 112. A second hook group 114 is parallel to the first hook group 108 and extends along the base 106 from the first end 110 to the second end 112. As such, the first hook group 108 and the second hook group 114 may extend along an entire length of the base 106. Alternatively, the hook member 102 may include one of the first hook group 108 or the second hook group 114.

A first seal 116 is coupled to the base 106, and extends from the base 106 between the first hook group 108 and the second hook group 114. The first seal 116 linearly extends along a length of the base 106 from the first end 110 to the second end 112, and may thereby extend along the entire length of the base 106. The first seal 116 may be parallel to the first hook group 108 and the second hook group 114. As shown, the first seal 116 may be spaced apart from the first hook group 108 and the second hook group 114. Optionally, the first seal 116 may abut into an edge of one or both of the first hook group 108 and/or the second hook group 114.

The loop member 104 includes a base 118 (for example, a second base), such as a planar strip of plastic, an elastomeric material, a film, fabric, and/or the like. A first loop group 120 is coupled to the base 118, and extends along the base 118 from a first end 122 to an opposite second end 124. A second loop group 126 is parallel to the first loop group 120 and extends along the base 118 from the first end 122 to the second end 124. Accordingly, the first loop group 120 and the second loop group 126 may extend along an entire length of the base 118. Alternatively, the loop member 104 may include one of the first loop group 120 or the second hook group 126.

A second seal 128 is coupled to the base 118, and extends from the base 118 between the first loop group 120 and the second loop group 126. The second seal 128 linearly extends along a length of the base 118 from the first end 122 to the second end 124, and may thereby extending along an entire length of the base 118. The second seal 128 may be parallel to the first loop group 120 and the second loop group 126. As shown, the second seal 128 may be spaced apart from the first loop group 120 and the second loop group 126. Optionally, the second seal 128 may abut into an edge of one or both of the first loop group 120 and/or the second hook group 126.

As shown, the second seal 128 may be wider than the first seal 116. The wider second seal 128 allows for misalignment when the hook member 102 is mated with the loop member 104. That is, the wider second seal 128 provides a greater surface onto which the first seal 116 is able to engage, thereby reducing the need for a precise alignment and connection between the hook member 102 and the loop member 104. Optionally, the first seal 116 may be wider than the second seal 128. In at least one other embodiment, the first seal 116 and the second seal 128 may have substantially the same width.

When coupled together, the first and second seals 116 and 128 provide a compressible, elastic, and fluid tight barrier. For example, the first and second seals 116 and 128 may be formed of closed-cell foam, an elastomeric material (such as rubber), silicone, fabric, and/or the like. It has been found that the closed-cell foam, in particular, provides an effective fluid-tight seal, while also being relatively light and moisture resistant. As such, the closed-cell foam may be used with applications that seek to reduce overall weight of components (such as with respect to aircraft). In at least one embodiment, the first and second seals 116 and 128 may be formed of the same type of material. In at least one other embodiment, the first and second seals 116 and 128 may be formed of different types of materials. For example, the first seal 116 may be formed of a closed-cell foam, while the second seal 128 may be formed of an elastomeric material.

As described herein, the sealable securing system 100 includes the hook member 102 including the first base 106, at least one hook group 108 and/or 114 coupled to the first base 106, and the first seal 116 coupled to the first base 106. The loop member 104 includes the second base 118, at least one loop group 120 and/or 126 coupled to the second base 118, and the second seal 128 coupled to the second base 118. The hook member 102 is removably secured to for example, selectively connectable to and disconnectable from) the loop member 104. The hook groups 120 and/or 126 securely connects to the at least one loop group when the hook member 102 is connected to the loop member 104, and the first seal 116 sealingly engages the second seal 128 when the hook member 102 is connected to the loop member 104.

In at least one embodiment, the hook groups 108, 114 and the first seal 116 may be secured to the first base 106 through a pressure sensitive adhesive. Similarly, the loop groups 120, 126, and the second seal 128 are secured to the second base 118 through a pressure sensitive adhesive. Further, the hook member 102 and the loop member 104 may be secured to components through a pressure sensitive adhesive, bonding, fasteners, and/or the like.

FIG. 2 illustrates an end view of the sealable securing system 100 including the hook member 102 and the loop member 104 in a connected state. In order to connect the hook member 102 to the loop member 104, the hook member 102 is aligned with the loop member 104 so that the first and second hook groups 108 and 114 engage the first and second loop groups 120 and 126. The first and second hook groups 108 and 114 engage the first and second loop groups 120 and 126 to provide a secure connection therebetween. As the first and second hook groups 108 and 114 secure to the first and second loop groups 120 and 126, the first seal 116 compresses into the second seal 128, thereby providing a fluid-tight sealing interface therebetween. As such, in the connected state, the sealable securing system 100 provides a fluid-tight sealing interface, by way of the first seal 116 and the second seal 128 compressed into one another, between the hook member 102 and the loop member 104. The fluid-tight sealing interface may run an entire length of the hook member 102 and the loop member 104 in the connected state, such as if the first seal 116 extends along an entire length of the hook member 102 and the second seal 128 extends along an entire length of the loop member 104.

As shown in FIG. 2, the wider second seal 128 provides a relatively large surface area onto which the first seal 116 may seat and compressively engage the second seal 128. Consequently, the sealable securing system 100 provides greater tolerance for mating the hook member 102 to the loop member 104, which does not require a precise alignment and positioning between the first seal 116 and the second seal 128 (thereby allowing for an easier and simpler connection process).

The first base 106 and the second base 118 include outer surfaces 130 and 132, respectively, that are configured to be secured to respective components. For example, the outer surfaces 130 and 132 may include adhesives that are configured to secure to components. In at least one other embodiment, the outer surfaces 130 and 132 may be cured and/or bonded to components. In at least one other embodiment, the outer surfaces 130 and 132 may be secured to components through stitches, woven fabric, fasteners, and/or the like. In at least one embodiment, the first base 106 and the second base 118 may each be double-sided tape.

The hook member 102 securely and removably connects to the loop member 104 via the mating of the hook groups 108, 114 with the loop groups 120, 126. The hook member 102 may be selectively removed from the loop member 104, such as by an individual pulling the hook member 102 off the loop member 104, or vice versa, thereby separating the hook groups 108, 114 from the loop groups 120, 126. The hook groups 108, 114 and the loop groups 120, 126 are resilient and configured to selectively connect to one another, as desired. In this manner, the sealable securing system 100 provides a reusable sealing connection.

FIG. 3 illustrates a top view of the sealable securing system 100 including the hook member 102 secured to a first component 200, and the loop member 104 secured to a second component 202, according to an embodiment of the present disclosure. The first component 200 having the hook member 102 and the second component 202 having the loop member 104 provides a component connection system 203. The hook member 102 may extend along an edge 204 of the first component 200, while the loop member 104 may extend along an edge 206 of the second component 202. Optionally, the hook member 102 and the loop member 104 may extend along more than one respective edge of the first component 200 and the second component 202, respectively. Optionally, the hook member 102 may be secured to the second component 202, while the loop member 104 may be secured to the first component 200.

FIG. 4 illustrates a lateral view of the first component 200 connected to the second component 202 via the sealable securing system 100. Referring to FIGS. 3 and 4, the first component 200 may be a first insulation blanket that is configured to be positioned within an aircraft. The second 202 may be a second insulation blanket that is configured to be positioned within the aircraft. The first component 200 securely connects to the second component 202 via the sealable securing system 100. In particular, the hook member 102 sealingly and secureably connects to the loop member 104 (as described herein), thereby securing the first component 200 to the second component 202.

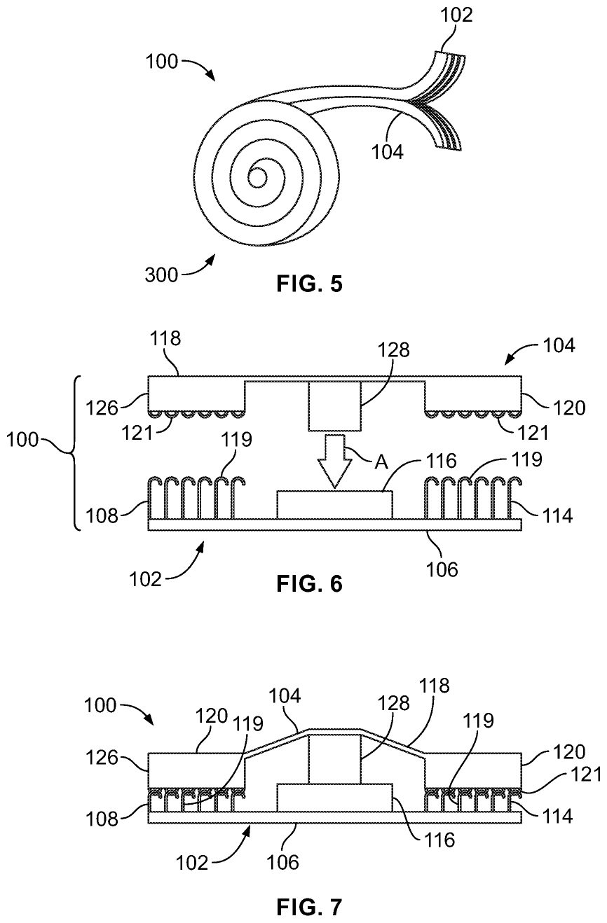

FIG. 5 illustrates a perspective lateral view of the sealable securing system 100, according to an embodiment of the present disclosure. The sealable securing system 100 may be manufactured as a roll or spool 300 in which the hook member 102 is coupled to the loop member 104, as described herein. A desired length of the sealable securing system 100 may be unrolled from the roll 300 and cut at the desired length. The hook member 102 may then be disconnected from the loop member 104, so that the hook member 102 may be secured to a first component (such as the first component 200 shown in FIGS. 3 and 4), and the loop member 104 may be secured to a second component (such as second component 202 shown in FIGS. 3 and 4).

FIG. 6 illustrates an end view of the sealable securing system 100 in a disconnected state, according to an embodiment of the present disclosure. As shown in FIG. 6, the first seal 116 may be wider than the second seal 128. Optionally, the second seal 128 may be wider than the first seal 116. The first seal 116 and the second seal 128 may be a formed as rectangular cross-sectional ridges, bars, beds, plates, or the like. Optionally, the first seal 116 and the second seal 128 may be shaped having various other cross-sections, such as circular, semi-circular, triangular, or the like.

The hook groups 108 and 114 each include a plurality of hooks 119. Similarly, the loop groups 120 and 126 each include a plurality of loops 121. The hooks 119 are configured to selectively mate with the loops 121.

In order to secure the hook member 102 to the loop member 104, the first seal 116 and the second seal 128 are faced towards one another, and linearly aligned. The wider first seal 116 allows for greater alignment tolerance between the first seal 116 and the second seal 128. Once the first seal 116 and the second seal 128 are linearly aligned, the hook member 102 and the loop member 104 are urged together in the direction of arrow A.

FIG. 7 illustrates an end view of the sealable securing system 100 in a connected state, according to an embodiment of the present disclosure. In the connected state, the hooks 119 of the hook groups 108 and 114 securely hook into the reciprocal loops 121 of the loop groups 120 and 126, thereby securely connecting the hook member 102 to the loop member 104. At the same time, the first seal 116 and the second seal 128 compress together, thereby providing a fluid-tight, sealing interface within the sealable securing system 100.

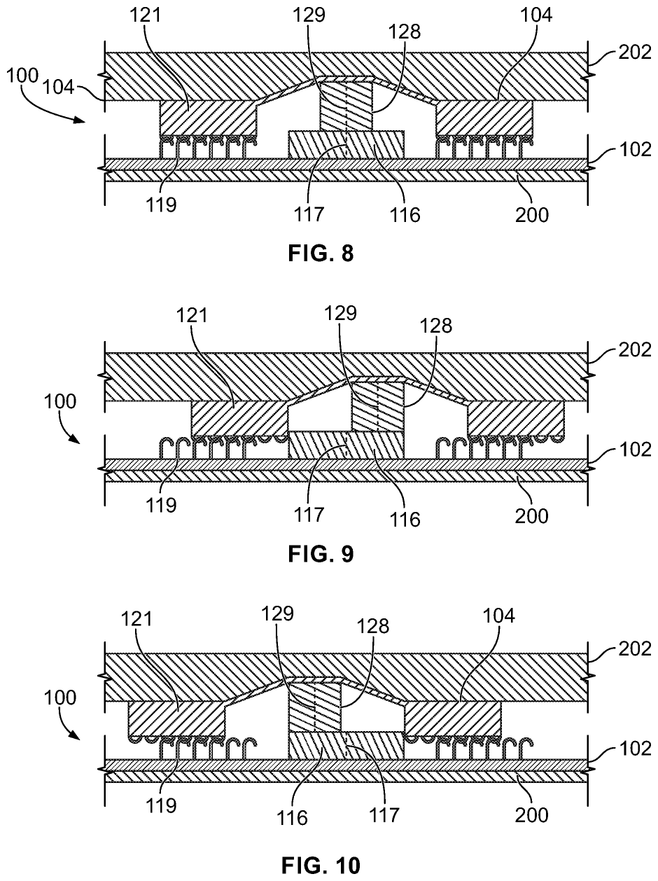

FIG. 8 illustrates an end view of the first component 200 connected to the second component 202 by the sealable securing system 100 in which the first seal 116 and the second seal 128 are aligned along respective longitudinal axes 117 and 129, according to an embodiment of the present disclosure. FIGS. 9 and 10 illustrate end views of the first component 200 connected to the second component 202 by the sealable securing system 100 in which the first seal 116 and the second seal 128 are coupled together and offset from alignment along respective longitudinal axes 117 and 129. Referring to FIGS. 8-10, because the first seal 116 is substantially wider than the second seal 129, the first and second components 200 and 202 may be secured together such that the first seal 116 need not be precisely aligned and mated with the second seal 128, such as by a precise alignment of the longitudinal axis 117 of first seal 116 and the longitudinal axis 129 of the second seal 128. Accordingly, the process of securing the first component 200 to the second component 202 is simpler and quicker.

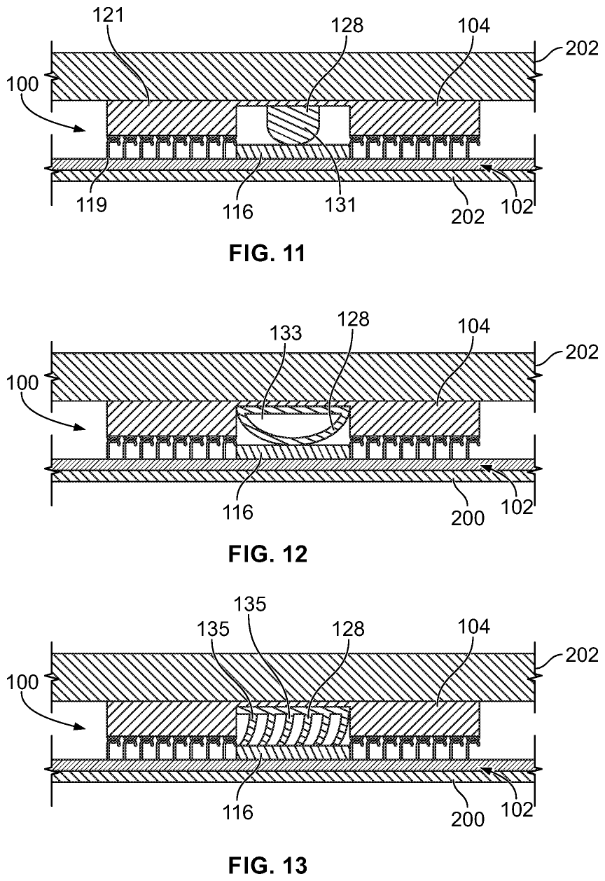

FIG. 11 illustrates an end view of the first component 200 connected to the second component 200 by the sealable securing system 100, according to an embodiment of the present disclosure. In this embodiment, the second seal 128 may include an outwardly-bowed surface 131. The second seal 128 may be formed as a rounded seal having the outwardly-bowed surface 131, which may allow for increased engagement between the hooks 119 and the loops 121. Further, the rounded, outwardly-bowed surface 131 allows for increased angular and/or radial connection between the first seal 116 and the second seal 128. Optionally, the first seal 116 may be formed having the outwardly-bowed surface 131, while the second seal 128 may be formed as a wider, flat and planar seal. In at least one embodiment, both the first seal 116 and the second seal 128 may include a rounded, outwardly-bowed surface.

FIG. 12 illustrates an end view of the first component 200 connected to the second component 202 by the sealable securing system 100, according to an embodiment of the present disclosure. In this embodiment, the second seal 128 may be formed as a bulb seal 133. Optionally, the first seal 116 may be formed as a bulb seal, while the second seal 128 may be formed as a flat, planar seal. In at least one embodiment, each of the first seal 116 and the second seal 128 may be formed as bulb seals.

FIG. 13 illustrates an end view of the first component 200 connected to the second component 200 by the sealable securing system 100, according to an embodiment of the present disclosure. In this embodiment, the second seal 128 may include a plurality of resilient blade seals 135, which may be formed of an elastomeric material. Optionally, the first seal 116 may include blade seals while the second seal 128 may be formed as a flat, planar seal.

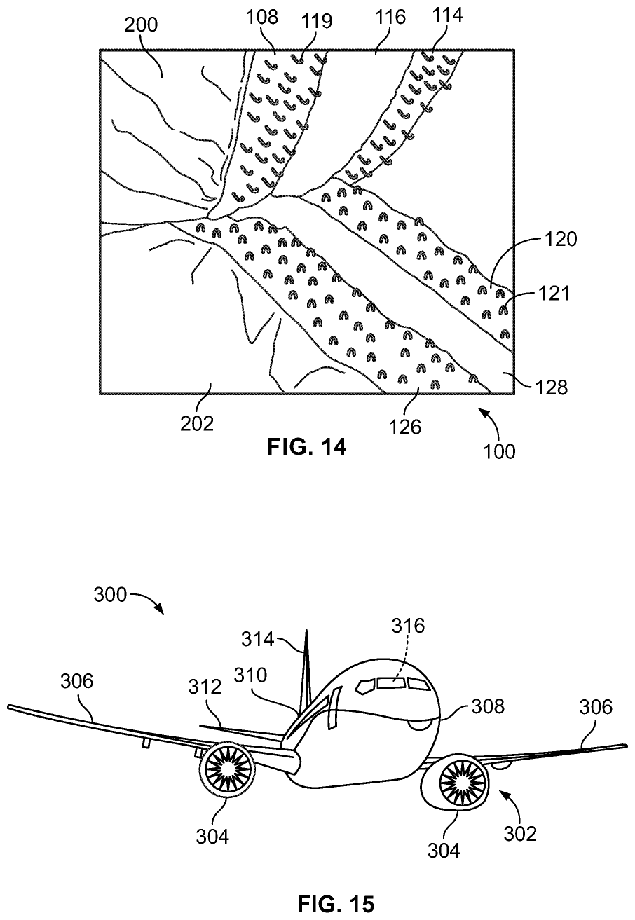

FIG. 14 illustrates a perspective view of the first component 200 connecting to the second component 202 by the sealable securing system 100, according to an embodiment of the present disclosure. As the hook groups 108 and 114 securely mate with the loop groups 126 and 120, respectively, the first seal 116 and the second seal 128 compressively engage together, thereby providing a fluid-tight sealing interface that prevents, minimizes, or otherwise reduces fluid (for example, air and water) infiltration through the connection interface defined by the sealable securing system 100 in the connected state between the first component 200 and the second component 202.

FIG. 15 illustrates a front perspective view of a vehicle, such as an aircraft 300, according to an embodiment of the present disclosure. The aircraft 300 includes a propulsion system 302 that may include two turbofan engines 304, for example. Optionally, the propulsion system 302 may include more engines 304 than shown. The engines 304 are carried by wings 306 of the aircraft 300. In other embodiments, the engines 304 may be carried by a fuselage 308 and/or an empennage 310. The empennage 310 may also support horizontal stabilizers 312 and a vertical stabilizer 314.

The fuselage 308 of the aircraft 300 defines an interior cabin 316, which may include a cockpit, one or more work sections (for example, galleys, personnel carry-on baggage areas, and the like), one or more passenger sections (for example, first class, business class, and coach sections), and an aft section. The interior cabin 316 includes components (such as insulation blankets) removably connected together through sealable securing systems 100, as shown and described with respect to FIGS. 1-15. Alternatively, instead of an aircraft, embodiments of the present disclosure may be used with various other vehicles, such as automobiles, buses, locomotives and train cars, seacraft, spacecraft, and the like. Further, embodiments of the present disclosure may be used with various other systems, structures, components, and/or the like, whether or not part of a vehicle.

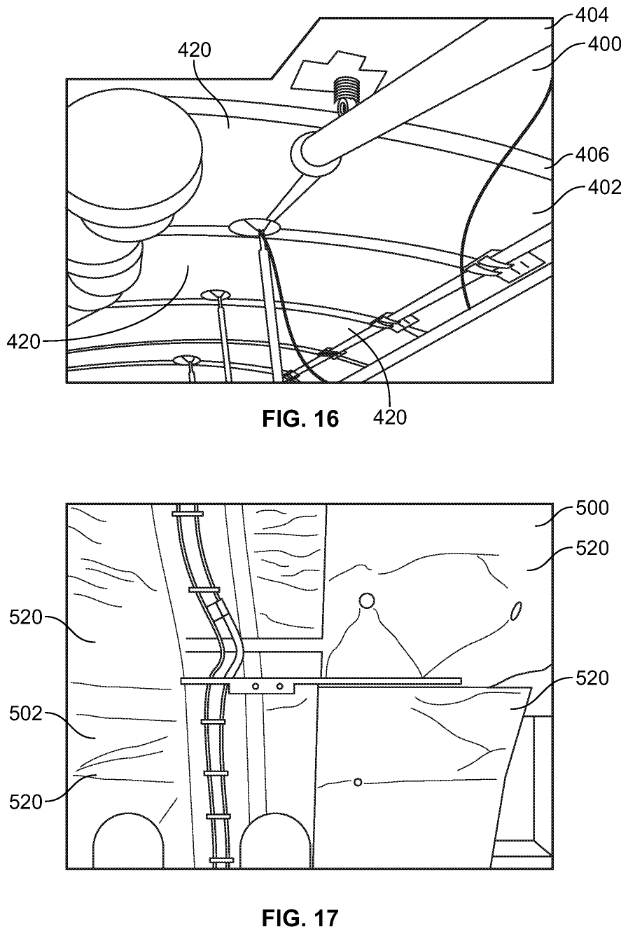

FIG. 16 illustrates a perspective internal view of a portion of a fuselage 400 of an aircraft, according to an embodiment of the present disclosure. The fuselage 400 defines an internal chamber 402 that may include structural supports, such as beams 404 and cross beams 406 that support panels. A plurality of insulation blankets 420 are secured to one another, the beams 404, and/or the cross beams 406. The insulation blankets 420 are removably connected to one another, the beams 404, and/or the cross beams 406 through sealable securing systems 100, such as shown and described with respect to FIGS. 1-15.

FIG. 17 illustrates a perspective internal view of a passenger cabin 500 of an aircraft, according to an embodiment of the present disclosure. The passenger cabin 500 includes an outer wall 502 that defines one or more windows 504. For the sake of clarity, an inner covering wall is not shown in FIG. 17. A plurality of insulation blankets 520 are secured to one another, and/or other structural features. The insulation blankets 520 are removably connected to one another, and/or the other structural features through sealable securing systems 100, such as shown and described with respect to FIGS. 1-15.

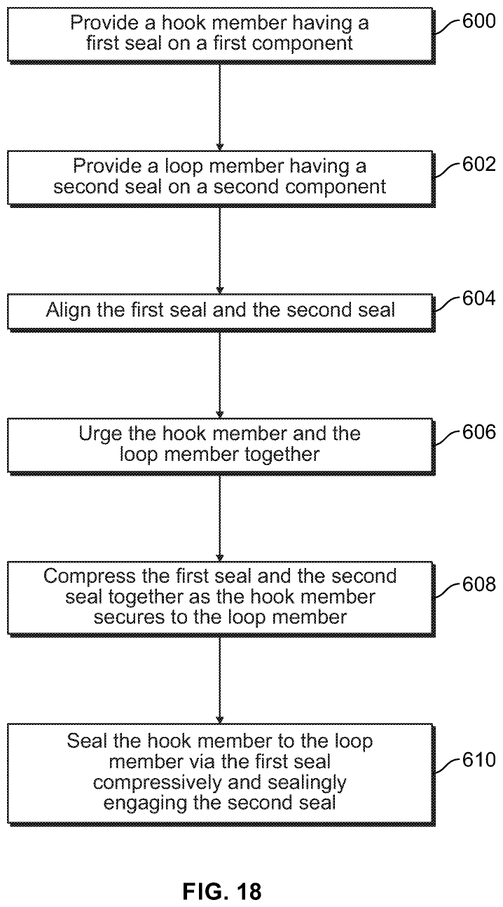

FIG. 18 illustrates a flow chart of a method of securely and sealingly connecting a first component to a second component, according to an embodiment of the present disclosure. In at least one embodiment, the systems and methods described herein provide sealable securing methods of reducing moisture infiltration into an interior cabin of a vehicle, such as an aircraft. Referring to FIGS. 1-4 and 18, at 600, the hook member 102 having the first seal 116 is provided on the first component 200. At 602, the loop member 104 having the second seal 128 is provided on the second component 202. Optionally, the loop member 104 may be provided on the first component 200, while the hook member 102 may be provided on the second component 202.

At 604, the first seal 116 and the second seal 128 are faced towards one another and linearly aligned. At 606, the hook member 102 and the loop member 104 are urged together.

At 608, the first seal 116 and the second seal 128 are compressed together as the hook member 102 secures to the loop member 104. At 610, the hook member 102 is sealed to the loop member 104 via the first seal 116 compressively and sealingly engaging the second seal 128, thereby providing a fluid-tight seal at a connection interface between the first component 200 and the second component 202.

As described herein, embodiments of the present disclosure provide systems and methods of preventing, minimizing, or otherwise reducing fluid infiltration through a hook and loop interface. Further, embodiments of the present disclosure provide systems and methods of preventing, minimizing, or otherwise reducing moisture from passing through connection interfaces of insulation blankets within an aircraft.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A sealable securing system, comprising:
a hook member including a first base, at least one hook group coupled to the first base, and a first seal coupled to the first base, wherein the hook member is configured to be secured to a first component; and
a loop member including a second base, at least one loop group coupled to the second base, and a second seal coupled to the second base, wherein the loop member is configured to be secured to a second component,
the hook member and the loop member being configured to removably secure to one another.

2. The sealable securing system of claim 1, wherein the at least one hook group securely connects to the at least one loop group when the hook member is connected to the loop member, and wherein the first seal sealingly engages the second seal when the hook member is connected to the loop member.

3. The sealable securing system of claim 1, wherein the at least one hook group comprises a first hook group spaced apart from a second hook group, and wherein the at least one loop group comprises a first loop group spaced apart from a second loop group.

4. The sealable securing system of claim 3, wherein the first seal extends from the first base between the first hook group and the second hook group, and wherein the second seal extends from the second base between the first loop group and the second loop group.

5. The sealable securing system of claim 1, wherein the at least one hook group and the first seal extend along an entire length of the first base, and wherein the at least one loop group and the first seal extend along an entire length of the second base.

6. The sealable securing system of claim 1, wherein the first seal is wider than the second seal.

7. The sealable securing system of claim 1, wherein the second seal is wider than the first seal.

8. The sealable securing system of claim 1, wherein each of the first seal and the second seal is formed of closed-cell foam.

9. The sealable securing system of claim 1, wherein the at least one hook group comprises a plurality of hooks, and the at least one loop group comprises a plurality of loops, wherein the plurality of hooks are configured to selectively mate with the plurality of loops.

10. The sealable securing system of claim 1, wherein one or both of the first seal or the second seal comprises a rounded, outwardly-bowed surface.

11. The sealable securing system of claim 1, wherein one or both of the first seal or the second seal comprises a bulb seal.

12. The sealable securing system of claim 1, wherein one of the first seal or the second seal comprises a plurality of resilient blade seals.

13. A sealable securing method, comprising:
providing a hook member including a first base, at least one hook group coupled to the first base, and a first seal coupled to the first base on a first component;
providing a loop member including a second base, at least one loop group coupled to the second base, and a second seal coupled to the second base on a second component; and
removably securing the hook member to the loop member.

14. The sealable securing method of claim 13, wherein the removably securing comprises:
securely connecting the at least one hook group to the at least one loop group when the hook member is connected to the loop member; and
engaging the first seal and the second seal when the hook member is connected to the loop member.

15. A vehicle comprising:
an interior cabin;
a first insulation blanket within the interior cabin;
a second insulation blanket within the interior cabin; and
a sealable securing system that sealingly and securely connects the first insulation blanket and the second insulation blanket, wherein the sealable securing system comprises:
a hook member secured to the first insulation blanket, wherein the hook member includes a first base, at least one hook group coupled to the first base, and a first seal coupled to the first base, wherein the at least one hook group comprises a plurality of hooks; and
a loop member secured to the second insulation blanket, wherein the loop member includes a second base, at least one loop group coupled to the second base, and a second seal coupled to the second base, wherein the at least one loop group comprises a plurality of loops, wherein the plurality of hooks are configured to selectively mate with the plurality of loops, wherein the first seal is wider than the second seal, or wherein the second seal is wider than the first seal,
the hook member and the loop member being removably secured to one another, wherein each of the first seal and the second seal is formed of closed-cell foam.

16. The vehicle of claim 15, wherein the at least one hook group securely connects to the at least one loop group when the hook member is connected to the loop member, and wherein the first seal sealingly engages the second seal when the hook member is connected to the loop member.

17. The vehicle of claim 15, wherein the at least one hook group comprises a first hook group spaced apart from a second hook group, wherein the at least one loop group comprises a first loop group spaced apart from a second loop group, wherein the first seal extends from the first base between the first hook group and the second hook group, and wherein the second seal extends from the second base between the first loop group and the second loop group.

18. The vehicle of claim 15, wherein one or both of the first seal or the second seal comprises a rounded, outwardly-bowed surface.

19. The vehicle of claim 15, wherein one or both of the first seal or the second seal comprises a bulb seal.

20. The vehicle of claim 15, wherein one of the first seal or the second seal comprises a plurality of resilient blade seals.
